(19) United States
(12) Patent Application Publication
(10) Pub. No.: US 2012/0237900 A1
(43) Pub. Date: Sep. 20, 2012

(54) CONICALLY TAPERED DENTAL IMPLANT

(75) Inventors: Cédric Lancieux, Chabeuil (FR); Catherine Priou, Le Pre Saint Gervais (FR)

(73) Assignee: ANTHOGYR, Sallanches (FR)

(21) Appl. No.: 13/512,364

(22) PCT Filed: Dec. 3, 2010
(86) PCT No.: PCT/IB10/55579

§ 371 Date: May 29, 2012

(30) Foreign Application Priority Data
Dec. 4, 2009 (FR) 09 58679

(51) Int. Cl. A61C 8/00

(52) U.S. Cl. 433/174; 433/173

(57) ABSTRACT

A dental implant (1) is intended to be inserted into the maxillary or mandibular bone of a patient, extending between a distal connection end (1a) and a proximal anchoring end (1b). The dental implant (1) has a maximum outside diameter (D) less than 3 mm over its entire length (L) and is provided with a receiving device (2) having a conically tapered female cavity (2a).

### TECHNICAL FIELD OF THE INVENTION

The present invention relates to the field of tooth prostheses and more particularly to a dental implant intended to be inserted into the maxillary or mandibular bone of a patient. The present invention also relates to a temporary cicatrization component and a final abutment, which are designed to cooperate with said dental implant.

When replacing a tooth by a prosthesis, a problem often arises in obtaining sufficient interdental space for insertion of a dental implant between two teeth.

This problem of space arises very particularly when replacing the mandibular incisors or maxillary lateral incisors, especially in cases of agenesis. It is then necessary to use a dental implant of small external diameter so as to be able to insert it and screw it in between two teeth.

The tooth prosthesis is mounted on a prosthesis support at the upper end of a final abutment connected to the dental implant. Since the forces of mastication can reach approximately 222 N near the incisors, it is essential that the connection between the final abutment and the dental implant is very strong.

In view of the small external dimensions of the dental implant, a first solution is to provide a final abutment produced in one piece with the dental implant. Thus, the document US 2006/0216673 describes a dental implant intended to be inserted into the jaw of a patient and extending between a distal end and a proximal anchoring end. The dental implant is produced in one piece with a final abutment, which extends away from the distal end of the dental implant.

With this type of one-piece dental implant, a problem arises between the surgical step of inserting the dental implant into the bone of the jaw and the step of fitting the tooth prosthesis in place on the prosthesis support provided by the abutment. This is because the time between these two steps varies between eight and twelve weeks. During this time, the dental implant must not be mechanically stressed by external forces, otherwise its osseointegration in the bone of the jaw is disturbed. However, the abutment protrudes above the gum and cannot be correctly protected from food during mastication. The protrusion of the abutment makes it impossible to fit a provisional protective tooth (made of plastic, for example) secured on the adjacent teeth by metal clips. As a result, the abutment is exposed to mastication forces between the surgical step and the step of fitting the tooth prosthesis in place. These forces are transmitted directly to the dental implant and are prejudicial to good osseointegration.

In order to solve this problem between the initial surgical step and the step of fitting the tooth prosthesis in place, a dental implant has been conceived that is able to cooperate with an attached final abutment by way of a releasable connection, as it is described in the document EP 1 849 431.

The document EP 1 849 431 thus describes a dental implant intended to be inserted into the jaw of a patient, extending between a distal connection end and a proximal anchoring end, comprising receiving means for the reception and releasable connection of an attached component, such as a final abutment, on its distal connection end.

The receiving means comprise an internally threaded female cavity. The final abutment is thus attached and fixed by screwing.

Since the dental implant and the final abutment are in two pieces, the dental implant can be inserted into the jaw of the patient without protruding above the gum and can be protected, for example by a provisional protective tooth, between the surgical step and the step of fitting the prosthesis in place. The final abutment is fixed in the dental implant only when the tooth prosthesis is being fitted in place, after the period of osseointegration.

The problem with this type of dental implant, combined with an attached final abutment, is that the material thickness around the internally threaded female cavity and the diameter of the screw intended to be inserted therein are too small to be able to mechanically withstand the high occlusal loads of mastication, which can be as high as approximately 222 N near the incisors, especially when the dental implant has a maximum external diameter of less than 3 mm along the entire length thereof. Premature fractures of the fixing screw and/or of the implant sometimes occur.

The documents US 2006/0121417 and EP 2 106 767 describe dental implants that are able to cooperate with an attached final abutment, of which the external diameter is too great to guarantee insertion between two teeth in the case when replacing the mandibular incisors or maxillary lateral incisors, especially in cases of agenesis.

The same is true of the dental implants from documents US 2006/0246398, EP 0 707 835, US 2007/0298379, US 2002/0031748, WO 2004/073541 and WO 01/80766, which all resort to fixing a final abutment by means of a screwed connection or a snap-fit connection.

### DISCLOSURE OF THE INVENTION

A first problem addressed by the invention is to design a dental implant which has an attached final abutment and which is able to be implanted in the jaw of a patient in order to replace teeth with a very small interdental space, as it is the case when replacing the mandibular incisors and the maxillary lateral incisors, especially in cases of agenesis.

At the same time, the present invention has the object of designing a dental implant of this kind, of which the connection to the attached final abutment is able to withstand high mastication forces of as high as approximately 222 N, for example.

To achieve these objects and others, the invention proposes a dental implant intended to be inserted into the maxillary or mandibular bone of a patient, extending between a distal connection end and a proximal anchoring end, comprising receiving means for the reception and releasable connection of an attached component, such as a final abutment or a cicatrization component, on its distal connection end, and having a maximum external diameter of less than 3 mm along the entire length thereof; according to the invention, the receiving means are formed by a conically tapered female cavity extending from the distal connection end toward the proximal anchoring end with decreasing internal diameter.

A conically tapered fit of this kind avoids constant thinning along a considerable height of the dental implant and efficiently limits the stress concentrations which are most often the cause of rupturing of the connection between a final abutment and a dental implant of the type described in the document EP 1 849 431.

The conically tapered fit permits an intimate and extensive join between the dental implant and the final abutment. Thus, the final abutment participates in taking up at least some of the forces of mastication.

Preferably, provision can be made that:

the dental implant is made of a biocompatible material such as titanium or a titanium alloy,

the conically tapered female cavity has a substantially frustoconical surface with an apex angle of between approximately 1.5 degrees and approximately 5 degrees, preferably substantially equal to approximately 3 degrees.

Such a cone angle is compatible with the height and width constraints of the dental implant for obtaining a connection with sufficient strength and stability, especially when the implant is made of a biocompatible metal, such as titanium or a titanium alloy.

Preferably, the conically tapered female cavity can have a length of between approximately 4 mm and approximately 5 mm. Such a cone length is compatible with the dental implant length, which is limited by the height of the patient's jaw bone.

Advantageously, the dental implant can have a length of between approximately 8 mm and approximately 16 mm. Such a dental implant length is compatible with most jaw bone heights.

Preferably, provision can be made that:

the dental implant is provided with an outer thread in order to be inserted by screwing into the maxillary or mandibular bone of the patient,

the dental implant has a female screwing socket arranged in a continuation of the conically tapered female cavity and accessible via the conically tapered female cavity.

The screwing force is thus applied nearest the proximal anchoring end, that is to say nearest the location where the screwing stresses are highest. It is thus possible to prevent torsional stresses being induced along the entire length of the implant. In the document EP 1 849 431, the screwing force is applied near the distal connection end of the dental implant, which induces torsional stresses along the entire length of the implant, or even deforms the implant along the length thereof, especially as the dental implant is hollow near its distal connection end.

Advantageously, the female screwing socket can have a cross section with three lobes. With such a cross section, the dental implant can be imparted a high screwing torque, which can reach 110 N.cm approximately.

Advantageously, the invention proposes a second assembly comprising a dental implant as described above, and comprising a final dental abutment extending between a lower end and an upper end intended to directly or indirectly support a tooth prosthesis, having first connection means in order to be received and connected releasably on the distal connection end of the dental implant, said first connection means being formed by a conically tapered male part, which extends from the lower end of the final abutment toward the upper end of the final abutment with increasing external diameter.

The lower end of the final abutment thus comes to intimately fill the female cavity of the receiving means of the dental implant, in order to better reinforce the latter and contribute to its strength by taking up at least some of the mastication forces.

Advantageously, the conically tapered male part of the final abutment can have a substantially frustoconical surface with an apex angle equal to that of the substantially frustoconical surface of the dental implant. This ensures that the connection between the final abutment and the dental implant is as intimate as possible, with the largest possible contact surface.

Preferably, the final abutment can be made of titanium or of a titanium alloy of the same kind as that forming the dental implant. With such contact by means of a conically tapered fit between two components made of titanium or of titanium alloy, it is possible not to degrade the surface of one or other of the components. In addition, micro-weld phenomena can arise between the two components, which phenomena then help retain the final abutment in the dental implant.

Advantageously, the internal diameter of the female cavity of the receiving means and the external diameter of the male part of the first connection means are such that, when the final abutment is engaged in the dental implant, the conically tapered fit is obtained over a substantially frustoconical surface with a length of between approximately 3.5 mm and approximately 4.4 mm. With such a length of conically tapered fit, it is possible to obtain, between the final abutment and the dental implant, a friction and contact surface having dimensions sufficient to ensure a satisfactory retention of the final abutment, especially when the final abutment and the dental implant are made of titanium or of titanium alloy.

Preferably, the invention proposes a first assembly comprising a dental implant as described above, and in which provision is made that:

the dental implant is combined with a temporary cicatrization component extending between a lower end and an upper end, having second connection means in order to be received and connected releasably on the distal connection end of the dental implant,

the second connection means of the temporary cicatrization component are formed by a conically tapered male part which extends from the lower end of the cicatrization component toward the upper end of the cicatrization component with increasing external diameter,

the temporary cicatrization component is made of a non-metallic biocompatible material.

The cicatrization component makes it possible to close the conically tapered female cavity between the initial surgical step and the step of fitting the tooth prosthesis in place, in order to avoid polluting the female cavity by the presence of food or of residues of blood, bone or flesh. Since the cicatrization component is made of non-metallic material, this avoids the creation of micro-welds with the dental implant (when the latter is metallic), thereby limiting the risk of too great a resistance when the cicatrization component is removed from the dental implant and thus avoiding damaging the osseointegration.

Advantageously, provision can be made that:

the dental implant is made of a metallic biocompatible material such as titanium or a titanium alloy,

the cicatrization component is made of polyetheretherketone.

Polyetheretherketone, also called PEEK, is not liable to damage the female cavity of the metallic dental implant but has, with metallic materials, a sufficient coefficient of friction to ensure a conical connection with satisfactory hold during the period of osseointegration, while permitting subsequent removal by a force unlikely to damage the osseointegration of the dental implant.

Advantageously, provision can be made that the internal diameter of the female cavity of the receiving means and the external diameter of the male part of the second connection means are such that, when the temporary cicatrization component is engaged in the dental implant, the conically tapered fit is obtained over a substantially frustoconical surface with a length of between approximately 2 mm and approximately 3.5 mm.

Such a length of conically tapered fit provides a surface of a size suitable for satisfactory retention of the cicatrization component in the dental implant.

Preferably, the upper end of the temporary cicatrization component can have third connection means for an extraction tool. The extraction tool can be, for example, in the form of pliers, which are tools commonly used in dentistry.

Advantageously, provision can be made that, when the temporary cicatrization component is engaged in the dental implant, the upper end of the temporary cicatrization component protrudes above the distal connection end of the dental implant by a length of between approximately 2.5 mm and approximately 6 mm.

Such a protrusion of the cicatrization component above the distal connection end of the dental implant makes it possible to fit in place, above the cicatrization component, protective means such as a provisional protective tooth made of plastic and secured on the adjacent teeth by metal clips. However, this protrusion still permits gripping by an extraction tool for removal of the cicatrization component.

### BRIEF DESCRIPTION OF THE DRAWINGS

Other objects, features and advantages of the present invention will become clear from the following description of particular embodiments, with reference being made to the attached figures in which:

FIG. 1 is a cross-sectional side view of a dental implant according to an embodiment of the invention;

FIG. 2 is a side view of the dental implant from FIG. 1;

FIG. 3 is a top view of the dental implant from FIGS. 1 and 2;

FIGS. 4 to 6 are side views of final abutments designed to be connected to the dental implant from FIGS. 1 to 3 in order to form second assemblies;

FIG. 7 is a side view of a cicatrization component designed to be connected to the dental implant from FIGS. 1 to 3 in order to form a first assembly;

FIG. 8 is a cross-sectional side view of a first assembly comprising a dental implant from FIGS. 1 to 3 together with the cicatrization component from FIG. 7; and

FIG. 9 is a cross-sectional side view of a second assembly comprising a dental implant from FIGS. 1 to 3 together with the final abutment from FIG. 4.

### DESCRIPTION OF PREFERRED EMBODIMENTS

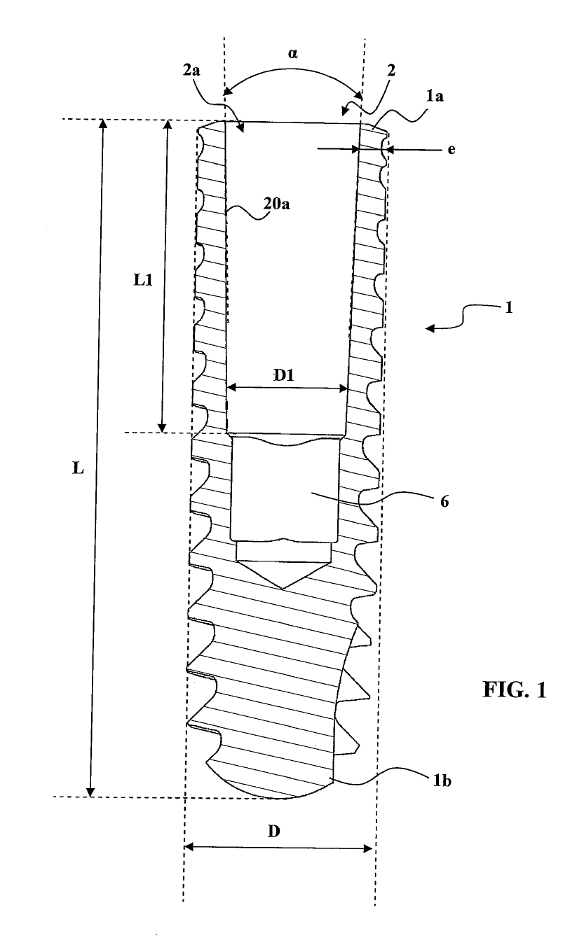

An embodiment of the dental implant 1 according to the invention is shown more particularly in FIGS. 1 to 3.

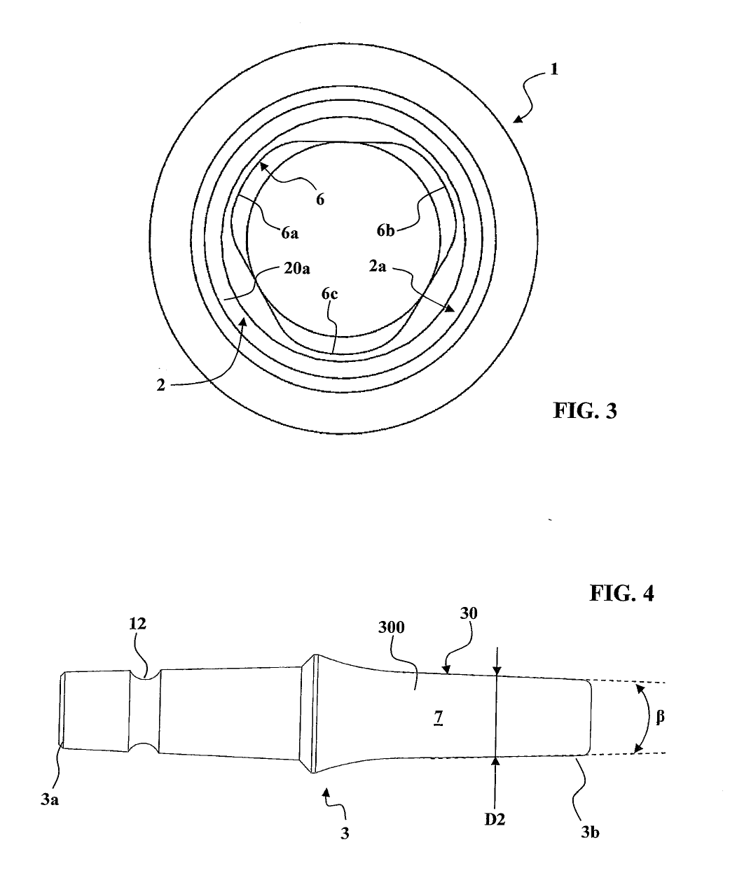

It will be seen particularly from FIG. 1 that the dental implant 1 extends between a distal connection end 1a and a proximal anchoring end 1b. The dental implant 1 comprises receiving means 2 for the reception and releasable connection of an attached component, such as a final abutment 3 (FIGS. 4 to 6) or a cicatrization component 8 (FIG. 7), on its distal connection end 1a.

The dental implant 1 has a maximum external diameter D of less than 3 mm along the entire length L thereof.

Preferably, provision can be made that the maximum external diameter D is less than or equal to approximately 2.8 mm. Such dimensions allow the dental implant 1 to be used to replace teeth with a very small interdental space, as is the case, for example, for the mandibular incisors and the maxillary lateral incisors, especially in cases of agenesis.

The receiving means 2 are formed by a conically tapered female cavity 2a extending from the distal connection end 1a toward the proximal anchoring end 1b with decreasing internal diameter D1.

The dental implant 1 is made of a biocompatible material such as titanium or a titanium alloy. The conically tapered female cavity 2a has a substantially frustoconical surface 20a with an apex angle α of between approximately 1.5 degrees and approximately 5 degrees. Preferably, the apex angle α will be substantially equal to approximately 3 degrees.

The conically tapered female cavity 2a has a length L1 of between approximately 4 mm and approximately 5 mm. The dental implant 1, for its part, has a length L of between approximately 8 mm and approximately 16 mm.

An apex angle α of approximately 3 degrees appears to be a good compromise for obtaining a sufficient length L1 for a satisfactory conical fit, while at the same time ensuring that a wall thickness e of the dental implant 1 near the distal connection end 1a is sufficient to give the dental implant 1 good mechanical strength.

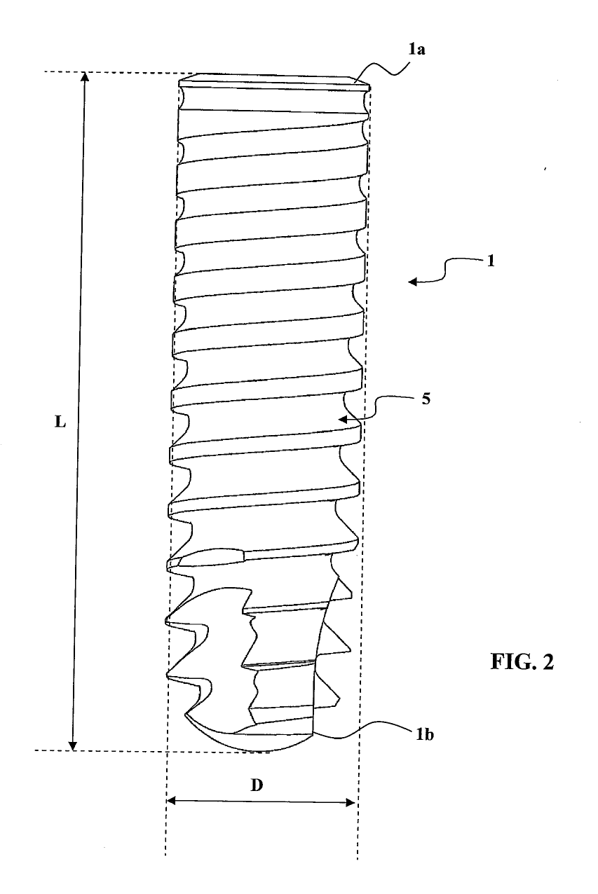

It will be seen more particularly from FIG. 2 that the dental implant 1 is provided with an outer thread 5 in order to be inserted by screwing into the maxillary or mandibular bone of the patient. To permit this screwing, the dental implant 1 has a female screwing socket 6, which can be seen more particularly in FIGS. 1 and 3.

The female screwing socket 6 is arranged in a continuation of the conically tapered female cavity 2a and is accessible via the conically tapered female cavity 2a. The female screwing socket 6 is thus arranged nearest to the proximal anchoring end 1b of the dental implant 1 in order to impart the screwing force directly thereto. It will be seen more particularly from FIG. 3 that the female screwing socket 6 has a cross section with three lobes 6a, 6b, 6c.

The dental implant in FIGS. 1 to 3 is intended to form a second assembly 200 by being connected to one of the final abutments 3 shown in FIGS. 4 to 6. The final abutments 3 extend between a lower end 3b and an upper end 3a intended to directly or indirectly support a tooth prosthesis. The function of the final abutment is to provide a mechanical projection above the patient's gum in order to receive and fix the prosthesis directly or indirectly. The final abutment 3 is therefore sometimes called a transmucosal post.

The final abutments 3 have first connection means 30 in order to be received and connected releasably on the distal connection end 1a of the dental implant 1. In this case, the first connection means 30 have a conically tapered male part 300, which extends from the lower end 3b toward the upper end 3a with increasing external diameter D2. The conically tapered male part 300 of the final abutment 3 has a substantially frustoconical surface 7 with an apex angle β substantially equal to the apex angle α of the substantially frustoconical surface 20a of the dental implant 1. The dental implant 1 and the final abutment 3 are thus assembled strictly by a conical connection. No screwed connection is used.

Advantageously, the final abutment 3 is made of titanium or of a titanium alloy of the same kind as that forming the dental implant 1.

FIG. 7 shows, on a larger scale, a temporary cicatrization component 8 intended to form a first assembly 100 by being connected to the dental implant 1 during the period of osseointegration. The temporary cicatrization component 8 extends between a lower end 8b and an upper end 8a. The temporary cicatrization component 8 has second connection means 80 in order to be received and connected releasably on the distal connection end 1a of the dental implant 1. The second connection means 80 have a conically tapered male part 800 which extends from the lower end 8b toward the upper end 8a with increasing external diameter D3. The conically tapered male part 800 has an apex angle γ which is substantially equal to the apex angle α. The dental implant 1 and the temporary cicatrization component 8 are thus assembled exclusively by a conical connection. No screwed connection is used.

The temporary cicatrization component 8 is made of a non-metallic biocompatible material, for example a plastic material such as polyetheretherketone (PEEK).

The upper end 8a of the temporary cicatrization component 8 is provided with third connection means 81. The third connection means 81 are designed to allow the temporary cicatrization component 8 to be gripped by an extraction tool (not shown), such as pliers. In this case, the connection means 81 comprise an external annular groove 810.

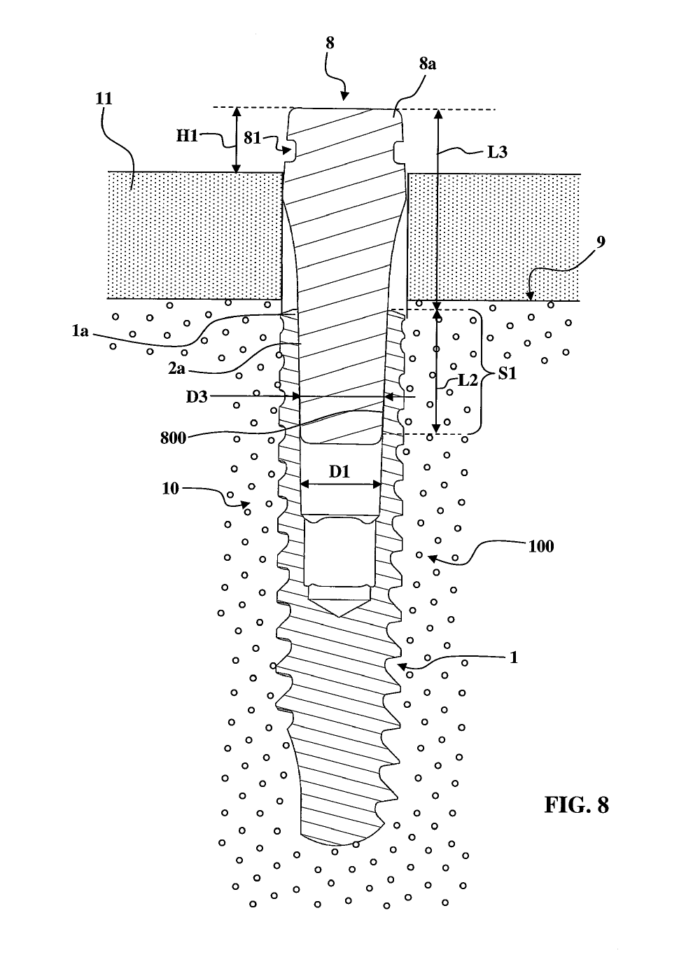

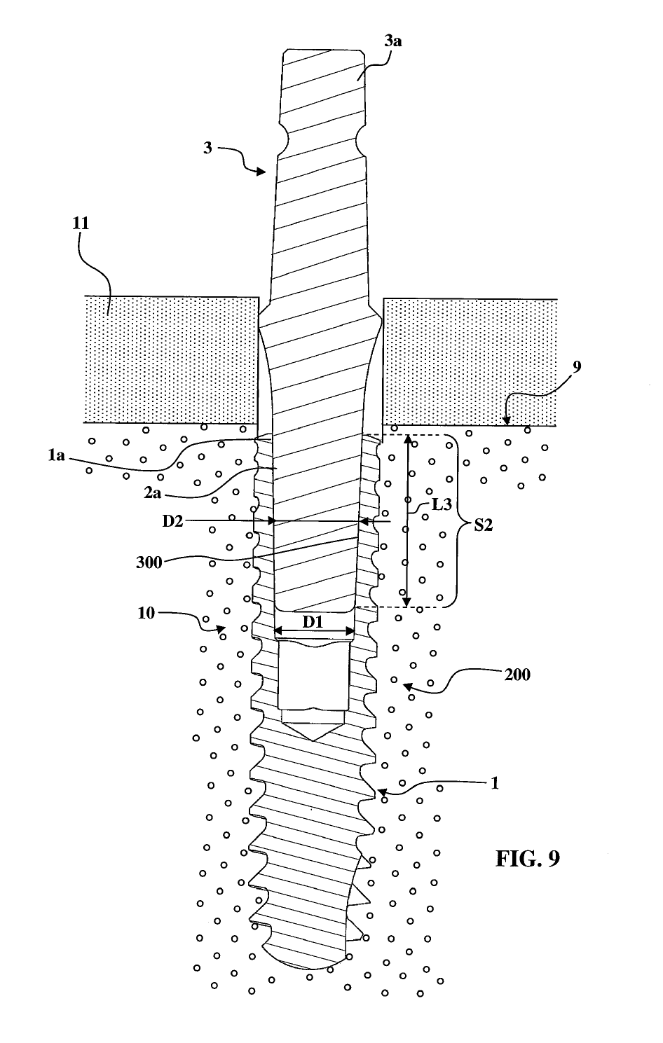

The replacement of a patient's tooth by a tooth prosthesis is performed in two separate steps illustrated in FIGS. 8 and 9. To make matters clearer for the reader, these figures do not show any adjacent tooth.

The first step, called the surgical step, involves screwing the dental implant 1 into the maxillary or mandibular bone of the patient. In this screwing procedure, the dental implant 1 is inserted until its distal connection end 1a is situated slightly below the upper surface 9 of the bone 10 (FIG. 8).

There then follows a period of cicatrization and osseointegration, which lasts for eight to twelve weeks and during which the dental implant 1 becomes integrated in the bone 10 of the jaw.

During this period of osseointegration, a first assembly 100 is formed by combination of a dental implant 1 and a temporary cicatrization component 8, by fitting the conically tapered male part 800 into the conically tapered female cavity 2a. The internal diameter D1 of the female cavity 2a of the receiving means 2 and the external diameter D3 of the male part 800 of the second connection means 80 are such that, when the temporary cicatrization component 8 is engaged in the dental implant 1, the conically tapered fit is obtained over a substantially frustoconical surface S1 with a length L2 of between approximately 2 mm and approximately 3.5 mm. Such a length L2 permits a sufficient hold of the cicatrization component 8 during the cicatrization step, while at the same time allowing the cicatrization component to be removed by application of a force unlikely to damage the osseointegration of the dental implant 1.

During the period of cicatrization, it is important that the upper end 8a of the cicatrization component protrudes above the gum 11 only by a small height H1 of approximately 1 mm. Such a height H1 allows the temporary cicatrization component 8 to be gripped by an extraction tool, such as pliers, by virtue of the third connection means 81, while at the same time preventing too high a projection above the gum 11, which would risk exposing the dental implant 1 to the forces of mastication or would prevent protection of the temporary cicatrization component 8 by a protective component, such as a provisional tooth secured on the adjacent teeth by metal clips for example.

To do this, provision can be made that, when the temporary cicatrization component 8 is engaged in the dental implant 1, the upper end 8a of the temporary cicatrization component 8 protrudes above the distal connection end 1a of the dental implant 1 by a length L3 of between approximately 2.5 mm and approximately 6 mm.

Once the period of cicatrization has ended, the temporary cicatrization component 8 is removed by an extraction tool, such as pliers, engaging in the third connection means 81.

A second assembly 200 is then formed by combination of the dental implant 1 and a final abutment 3, by fitting the conically tapered male part 300 into the conically tapered female cavity 2a (FIG. 9). The internal diameter D1 of the female cavity 2a of the receiving means 2 and the external diameter D2 of the male part 300 of the first connection means 30 are such that, when the final abutment 3 is engaged in the dental implant 1, the conically tapered fit is obtained over a substantially frustoconical surface S2 with a length L3 of between approximately 3.5 mm and approximately 4.4 mm.

Such a length L3 permits a sufficient hold of the final abutment 3 in the dental implant 1, especially when these are made of metal. Such a length L3 has proven particularly satisfactory in the case of a final abutment 3 and a dental implant 1 made of titanium or of titanium alloy, on account of the mutual coefficient of friction between these materials.

When the final abutment 3 is fitted conically in the dental implant 1, they are intimately connected such that the second assembly 200 thereby formed is able to withstand dynamic forces of mastication of approximately 222 N, or even as much as 265 N, despite the small external size of the second assembly 200, the dental implant 1 having a maximum external diameter D of less than 3 mm along the entire length L thereof.

When the dental implant 1 and the final abutment 3 are made of metal, micro-weld phenomena can also arise, which tend to reinforce the join between the dental implant 1 and the final abutment 3.

### Example

A dental implant 1 according to the invention was produced with the following parameters:

### L=14 mm

### D=2.8 mm

α=β3=30

### L1=4.6 mm

### L3=4 mm

material: T60 (unalloyed titanium)

Three examples of this dental implant 1, each equipped with a final abutment 3, were subjected to repeated cycles of application of a dynamic force of 265 N according to ISO 14801. These dental implants 1 did not break until after more than 2 700 000 cycles. Excellent results were also obtained with alloyed titanium, for example TA6V.

The same cycles were applied, under the same conditions, to examples of an “OsseoSpeed® 3.0 S” implant, which is sold by the company ASTRA TECH FRANCE, is made of titanium T60 and has a maximum external diameter of 3 mm. The connection between the final abutment and the dental implant is ensured by a screwed connection. The screwed connection was broken after approximately 225 cycles.

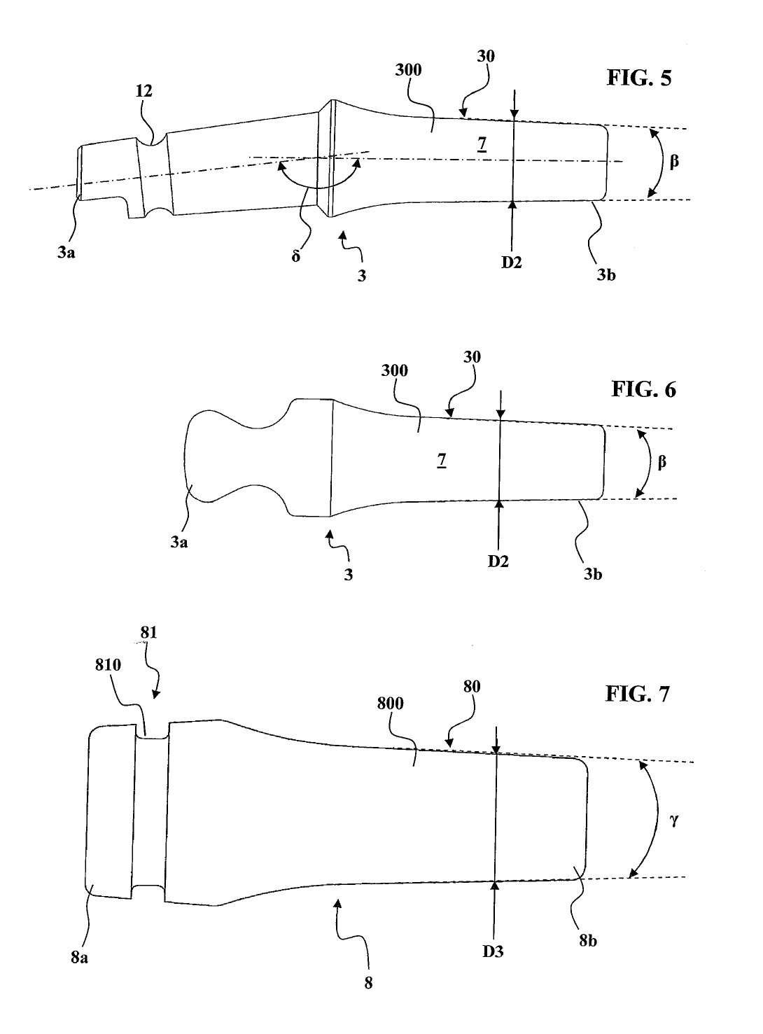

Different kinds of final abutments can be used, as are illustrated in FIGS. 4 to 6. In FIGS. 4 and 6, the final abutment 3 is a straight abutment, whereas the final abutment 3 in FIG. 5 is an angled abutment, the lower end 3b and the upper end 3a having between them an angle δ different than 180°. The means for direct or indirect reception of a prosthesis can also differ. In FIGS. 4 and 5, the receiving means comprise a peripheral annular groove 12 and also an upper end 3a of non-circular cross section for rotational indexing of the tooth prosthesis. In FIG. 6, the means for receiving the tooth prosthesis consist of a substantially ball-shaped upper end 3a, on which the prosthesis can be snap-fitted.

The present invention is not limited to the embodiments that have been explicitly described and instead it includes the various modifications and generalizations contained within the scope of the attached claims.

1. A dental implant (1) intended to be inserted into the maxillary or mandibular bone of a patient, extending between a distal connection end (1a) and a proximal anchoring end (1b), comprising receiving means (2) for the reception and releasable connection of an attached component, such as a final abutment (3) or a cicatrization component (8), on its distal connection end (1a), and having a maximum external diameter (D) of less than 3 mm along the entire length (L) thereof, wherein the receiving means (2) are formed by a conically tapered female cavity (2a), which extends from the distal connection end (1a) toward the proximal anchoring end (1b) with decreasing internal diameter (D1).

2. The dental implant (1) as claimed in claim 1, wherein:
the dental implant (1) is made of a biocompatible material such as titanium or a titanium alloy,
the conically tapered female cavity (2a) has a substantially frustoconical surface (20a) with an apex angle (α) of between approximately 1.5 degrees and approximately 5 degrees, preferably substantially equal to approximately 3 degrees.

3. The dental implant (1) as claimed in claim 2, wherein the conically tapered female cavity (2a) has a length (L1) of between approximately 4 mm and approximately 5 mm.

4. The dental implant (1) as claimed in claim 1, having a length (L) of between approximately 8 mm and approximately 16 mm.

5. The dental implant (1) as claimed in claim 1, wherein:
the dental implant (1) is provided with an outer thread (5) in order to be inserted by screwing into the maxillary or mandibular bone of the patient,
the dental implant (1) has a female screwing socket (6) arranged in a continuation of the conically tapered female cavity (2a) and accessible via the conically tapered female cavity (2a).

6. The dental implant (1) as claimed in claim 5, wherein the female screwing socket (6) has a cross section with three lobes (6a, 6b, 6c).

7. An assembly (200) comprising a dental implant (1) as claimed in claim 1, additionally comprising a final dental abutment (3) extending between a lower end (3b) and an upper end (3a) intended to directly or indirectly support a tooth prosthesis, having first connection means (30) in order to be received and connected releasably on the distal connection end (1a) of the dental implant (1), said first connection means (30) being formed by a conically tapered male part (300), which extends from the lower end (3b) of the final abutment (3) toward the upper end (3a) of the final abutment (3) with increasing external diameter (D2).

8. The assembly (200) as claimed in claim 7, wherein the conically tapered male part (300) of the final abutment (3) has a substantially frustoconical surface (7) with an apex angle (β) equal to that of the conically tapered female cavity (2a) of the dental implant (1).

9. The assembly (200) as claimed in claim 7, wherein the final abutment (3) is made of titanium or of a titanium alloy of the same kind as that forming the dental implant (1).

10. The assembly (200) as claimed in claim 7, wherein the internal diameter (D1) of the female cavity (2a) of the receiving means (2) and the external diameter (D2) of the male part (300) of the first connection means (30) are such that, when the final abutment (3) is engaged in the dental implant (1), the conically tapered fit is obtained over a substantially frustoconical surface (S2) with a length (L3) of between approximately 3.5 mm and approximately 4.4 mm.

11. The assembly (100) comprising a dental implant (1) as claimed in claim 1, wherein:
it additionally comprises a temporary cicatrization component (8) extending between a lower end (8b) and an upper end (8a), having second connection means (80) in order to be received and connected releasably on the distal connection end (1a) of the dental implant (1),
the second connection means (80) of the temporary cicatrization component (8) are formed by a conically tapered male part (800) which extends from the lower end (8b) of the cicatrization component (8) toward the upper end (8a) of the cicatrization component (8) with increasing external diameter (D3),
the temporary cicatrization component (8) is made of a non-metallic biocompatible material.

12. The assembly (100) as claimed in claim 11, wherein:
the dental implant (1) is made of a metallic biocompatible material such as titanium or a titanium alloy,
the cicatrization component (8) is made of polyetheretherketone.

13. The assembly (100) as claimed in claim 11, wherein the internal diameter (D1) of the female cavity (2a) of the receiving means (2) and the external diameter (D3) of the male part (800) of the second connection means (80) are such that, when the temporary cicatrization component (8) is engaged in the dental implant (1), the conically tapered fit is obtained over a substantially frustoconical surface (S1) with a length (L2) of between approximately 2 mm and approximately 3.5 mm.

14. The assembly (100) as claimed in claim 11, wherein the upper end (8a) of the temporary cicatrization component (8) has third connection means (81) for an extraction tool.

15. The assembly (100) as claimed in claim 11, wherein, when the temporary cicatrization component (8) is engaged in the dental implant (1), the upper end (8a) of the temporary cicatrization component (8) protrudes above the distal connection end (1a) of the dental implant (1) by a length (L3) of between approximately 2.5 mm and approximately 6 mm.
